(19) United States
(12) Patent Application Publication
(10) Pub. No.: US 2006/0064977 A1
(43) Pub. Date: Mar. 30, 2006

(54) Device for the detection of an actuation force of a brake pedal, and brake system

(75) Inventors: Benedikt Ohlig, Vallendar (DE); Wilfried Giering, Mendig (DE)

Correspondence Address: MACMILLAN, SOBANSKI & TODD, LLC, ONE MARITIME PLAZA - FOURTH FLOOR, 720 WATER STREET, TOLEDO, OH, 43604, US

(73) Assignee: Lucas Automotive GmbH

(21) Appl. No.: 11/240,339

(22) Filed: Sep. 30, 2005

Related U.S. Application Data
(63) Continuation of application No. PCT/EP04/03139, filed on Mar. 24, 2004.

(30) Foreign Application Priority Data
Apr. 2, 2003 (DE) 103 15 073.0

(51) Int. Cl. B60T 17/22

(52) U.S. Cl. 60/534

(57) ABSTRACT

The invention relates to a device for the detection of an actuation force of a brake pedal, comprising a force take-up element coupled to the brake pedal, and a force-transmitting element which is coupled to a brake system and is movable relative to the force take-up element, a sensor device being provided between the force take-up element and the force-transmitting element for the detection of at least one parameter characterizing the actuation force. In the case of this device, provision is made, for the purpose of compact design, whereby the force take-up element and the force-transmitting element are telescopically displaceable relative to one another, and whereby the sensor device is encased by the force take-up element and the force-transmitting element.

This application is a continuation of International Application No. PCT/EP2004/003139 filed Mar. 24, 2004, which claimed priority to German Patent Application No. 103 15 073.0 filed Apr. 2, 2003, the disclosures of which are incorporated herein by reference.

### BACKGROUND OF THE INVENTION

The present invention relates to a device for the detection of an actuation force of a brake pedal, having the features of the preamble of claim 1.

More recent types of vehicle brake systems are often of such design that they electronically detect a pedal actuation force exerted on a brake pedal, and influence or control a subsequent generation of a braking force in the brake system on the basis of the detected pedal actuation force. There is thus the possibility of brake boosting, in which the pedal actuation force exerted on the brake pedal is introduced into the brake system and boosted by means of a brake booster. Equally, there are solutions in which the pedal actuation force exerted on the brake pedal is fully dissipated in normal operation of the brake system and the braking force is generated in its entirety by the brake system solely on the basis of the detected pedal actuation force.

Such a device is known from, for example, EP 1 003 658 B1, and corresponding U.S. Pat. No. 6,233,932, wherein provision is made for a fully hydraulic braking-force generator in which a position sensor detects the travel of the current pedal actuation, said travel providing information on the current pedal actuation force. In the case of the solution disclosed in this prior art, the position sensor is disposed in the area of a pedal simulation device. It must be designed to be able to detect the position of the pedal simulation device over the entire possible pedal travel. It is therefore necessary for the position sensor to be of correspondingly large structural design. This results in an undesirable enlargement of the system.

Additionally known, from DE 41 30 383 A1, is a braking-force generator in which a force output element, which is coupled to a friction brake, is realized as a telescopic element, a pressure cell being disposed between two telescopic components of the force output element. In addition to damping characteristics due to elasticity, the pressure cell is additionally intended to serve the purpose of providing measurement values for the braking force generated by the braking-force generator, which measurement values then serve as feedback of a control system for closed-loop control of the braking-force generator.

By contrast, it is an object of the present invention to provide a device, of the type stated at the outset, which permits reliable ascertainment of the actuation force of a brake pedal, while being of a compact and inexpensive design.

### BRIEF SUMMARY OF THE INVENTION

The solution according to the invention renders possible a compact design, owing to the telescopic-type realization of a force take-up element and a force-transmitting element. Moreover, the relatively sensitive sensor device can be encased in the components force take-up element and force-transmitting element, and thus better protected against environmental influences which shorten its service life.

A development of the invention provides for a spring arrangement which forces the force take-up element and the force-transmitting element apart from one another. It is thereby possible to ascertain the actuation force on the basis of the travel of a compression of the spring arrangement. In order to keep the spring excursions small, the spring arrangement is to be realized with a correspondingly high spring hardness. This enables the compactness of the device according to the invention to be further improved.

The invention makes provision, in an embodiment variant, whereby the spring arrangement comprises a conical compression spring which is compressible in the direction of a longitudinal axis running through its centre. Such a conical compression spring may consist of a sheet-metal strip, running in the form of a spiral, whose edges running in the form of a spiral run on conical surfaces assigned to said sheet-metal strip. Such conical compression springs have the advantage that they require high compressive forces for their compression, with a relatively small required structural space and a small spring excursion. Moreover, such conical compression springs are markedly stable and robust when in block. They then act as a rigid force-transmitting element without further spring action.

In addition, or alternatively, provision may be made whereby the spring arrangement comprises a helical compression spring. A compact and robust design of the device according to the invention is obtained particularly if the spring arrangement is encased by the force take-up element and the force-transmitting element. Alternatively, provision may be made whereby the spring arrangement encompasses at least one of the components force take-up element and force-transmitting element.

In order that the device can be combined to form a stable preassembled assembly to facilitate fitting in a brake system, a development of the invention makes provision whereby the spring arrangement is integrally connected, for example by welding, adhesive bonding, or the like, to one of the components force take-up element and force-transmitting element. The spring arrangement may of course also be connected to both components force take-up element and force-transmitting element.

In respect of the sensor device, provision may be made whereby same comprises a proximity sensor, in particular a Hall sensor. The use of a Hall sensor has the advantage of easy availability at low cost.

In order, on the one hand, to limit the relative movement, referred to at the outset, between the force take-up element and the force-transmitting element in respect of stroke and, on the other hand, to define it in respect of its degrees of freedom, provision may furthermore be made according to the invention whereby a guide pin passes through the force take-up element transversely relative to the direction of the relative movement of force take-up element and force-transmitting element, and is displaceable into a guide recess in the force-transmitting element in the direction of the relative movement. The guide pin is thus able to move to a limited extent within the guide recess during a relative movement between the force take-up element and the force-transmitting element. In order to prevent a perceptible striking of the guide pin on an end of the guide recess in the case of a pedal actuation with a high actuation force, which may result in a maximum displacement of the guide pin in the guide recess, the guide pin may be provided with a covering layer of damping material, for example rubber material or the like. Equally, it is possible, according to the invention, to further limit the movement of the guide pin within the guide accommodation such that, at its maximum excursion, it does not strike on the end of the guide accommodation. The guide pin may then also be provided with a friction-reducing coating, for example a Teflon film or the like.

The compactness of the device according to the invention may be further improved in that a sensor component of the sensor device is realized on a sensor carrier, the sensor carrier being mounted on a component of force take-up element and force-transmitting element, and in that a complementary sensor component of the sensor device is mounted on the respectively other component of force take-up element and force-transmitting element, or can be coupled to same. The sensor carrier may, for example, be inserted in a slot provided for it on one of the components of force take-up element and force-transmitting element, such that, upon assembly, said sensor carrier is necessarily brought into a predefined desired position. Alternatively, or additionally, provision may be made whereby the sensor carrier is mounted on the force take-up element and is positioned by means of the guide pin. Furthermore, it is possible for the sensor component to be firmly attached to the sensor carrier and for the complementary sensor component to be guided so as to be movable relative to the sensor component. Upon a pedal actuation, the complementary sensor component can then be displaced relative to the sensor component through establishment of a mechanical coupling to the moving force take-up element or force-transmitting element, and the movement thereby detected.

By means of the invention, it is possible to use the signals output by the sensor device to control various components of a vehicle brake system. Thus, for example, a brake light can be activated as soon as the sensor device detects a certain minimum excursion. Furthermore, an ESP (Electronic Stability Program) system or an ACC (Autonomous Cruise Control) system can be controlled using the actuating force detected by means of the invention, in which case it is possible to dispense with additional pressure sensors.

The invention furthermore relates to a force-admitting element of a brake system of a vehicle, for introducing a pedal actuation force, exerted on a brake pedal, into the brake system, the force-admitting element comprising a device according to the type described above. For example, the force-admitting element may be divided into two, namely, into the force take-up element and the force-transmitting element that can be displaced relative to the latter.

The invention furthermore relates to a vehicle brake system realized with a device according to the type described above.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a perspective, partially sectional view of a device according to the invention;

FIG. 2 shows a sectional view corresponding to the section II-II from FIG. 1;

FIG. 3 shows a sectional view corresponding to the section III-III in FIG. 1, and

FIG. 4 shows a partially sectional view of a second exemplary embodiment of the device according to the invention.

### DETAILED DESCRIPTION OF THE INVENTION

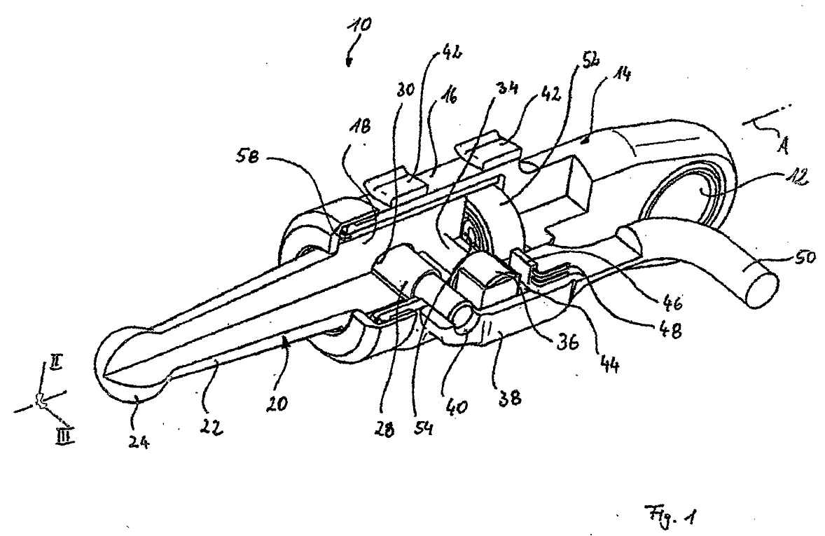

Represented in FIG. 1, and denoted in general by the reference 10, is a device according to the invention, in the form of a force-admitting element of a brake system for a vehicle. The device 10 is coupled, by means of a seating eye 12, to a brake pedal, which is not shown. The seating eye 12 is realized in a free end of a force take-up element 14. At its other end, the force take-up element 14 has a hollow cylindrical portion 16. Extending into this hollow cylindrical portion is a cylindrical end 18 of a force-transmitting element 20. The force-transmitting element 20 has a shaft 22 which is spherical in form at its free end at 24. The spherical end 24 is connected to the brake system, for example to a brake booster.

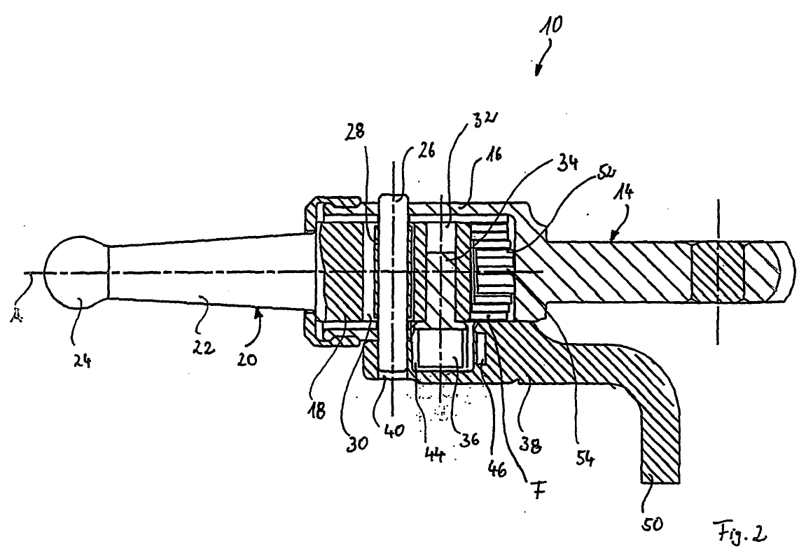

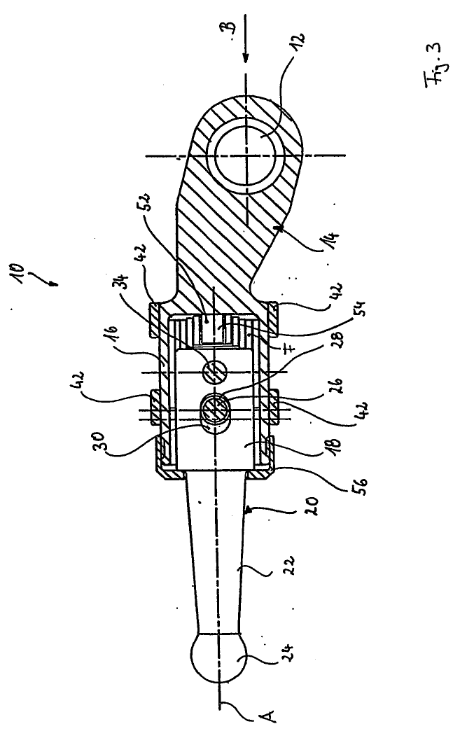

For the purpose of further describing the device, reference is additionally made to the sectional representations according to FIGS. 2 and 3.

A guide pin 26, which is fixed in the walls of the hollow cylindrical portion 16, passes through said cylindrical portion. This guide pin, in its region which runs within the hollow cylindrical portion 16, has a Teflon sleeve 28. The guide pin 26 extends through a corresponding guide recess 30, which is extended in the direction of the longitudinal axis A, within the solid cylindrical end 18 of the force-transmitting element 20. The force-transmitting element 20 can thereby be displaced, with little friction, in the axial direction relative to the force take-up element 14 to the extent to which the guide pin 26 is displaceable within the guide recess 30.

The cylindrical end 18 has a further recess 32, running substantially orthogonally relative to the longitudinal axis A. Inserted in this recess 32 is a carrier pin 34, which carries a permanent magnet 36 at it end which projects out of the recess 32.

At one of its ends, the guide pin 26 projects out beyond the hollow cylindrical portion 16. A sensor carrier 38 is mounted on this end which projects out of the hollow cylindrical portion 16. For this purpose, the sensor carrier 38 has a bore 40 whose inner diameter is matched to the outer diameter of the pin 26, so that the sensor carrier 38 can be positioned in the direction of the longitudinal axis A by being mounted on the pin 26. The sensor carrier 38 additionally has snap-action arms 42, by means of which it encompasses the outer circumference of the hollow cylindrical portion 16 of the force take-up element 14. The sensor carrier 38 is realized with a recess 44, in which the permanent magnet 36 that moves together with the force-transmitting element 20 is able to move to the same extent that the force-transmitting element 20 is able to move relative to the force take-up element 14 because of the interaction of the guide pin 26 and the guide recess 30. Integrated into the sensor carrier 38 is a sensor element 46 which is coupled, via leads 48, to an electronic control unit, not shown. The leads 48 are routed away from the device 10 via a lead conduit 50, which is shown in schematic form only in the figures.

A conical compression spring 52 is provided between the cylindrical end 18 of the force-transmitting element 20 and the base, opposite the latter in FIGS. 1 to 3, of the cavity of the hollow cylindrical portion 16.

The conical compression spring 52 is produced from a strip of material having a high spring stiffness, e.g. from spring steel. The strip has a substantially rectangular cross-section which is curved in the form of a spiral, starting from a central portion 54 located in the region of the longitudinal axis A. It can be seen from FIGS. 2 and 3 that the spiral, which is described by a certain level line, e.g. the neutral fibre F of the strip, does not lie in a plane, but instead runs in the form of a spiral on a conical surface. Such a design of the conical compression spring 52 renders possible compression through pressing-in of the central portion 54 in the axial direction, towards the cylindrical end 18 of the force-transmitting element 20. Although the conical compression spring 52 permits only relatively small spring excursions, namely, only to the extent to which the central portion 54 can be pressed-in in the axial direction to the cylindrical end 18, very high spring forces are nevertheless required for such a compression. Moreover, the conical compression spring 52 has the advantage that it is relatively unaffected by high forces. As soon as it is set to block by a high pedal actuation force, it acts as a rigid force-transmitting element. If the pedal actuation force is reduced to zero, the conical compression spring 52 is released again, and assumes its original shape.

It is also to be noted that the cavity of the hollow cylindrical portion 16 is encased by a sleeve 56 which is screwed on to the free end of the hollow cylindrical portion 16 and which has a central aperture through which the shaft 22 of the force-transmitting element 20 projects. Finally, it is pointed out that the force-transmitting element 20 is guided, with little play and little friction, in the hollow cylindrical portion 16 by means of a bearing bushing 58 of a friction-reducing material, e.g. Teflon.

When the device 10 is in operation, a pedal actuation force B acts on the force take-up element 14 and presses it towards the force-transmitting element 20. The conical compression spring 52 is thereby compressed in accordance with the magnitude of the pedal actuation force B. This results in the force take-up element 14 and the force-transmitting element 20 drawing closer together and, consequently, in the permanent magnet 36 drawing closer to the sensor element 46. The sensor element 46 detects the approach of the permanent magnet 36, e.g. through detection of a Hall effect, and sends a corresponding output signal, via the leads 48, to the control unit, not shown. The latter uses the detected data, taking account of the spring hardness of the conical compression spring 52, to ascertain the pedal actuation force B currently applied to the force take-up element 14, and control a vehicle brake system, not shown, in a corresponding manner. Depending on the travelled spring excursion of the conical compression spring 52, the vehicle brake system then generates a braking force which serves to brake the vehicle.

Following release of the brake pedal, i.e. following reduction of the pedal actuation force B to the amount zero, the conical compression spring 52 is released again, insofar as possible, and the device 10 assumes the initial position shown in FIGS. 1 to 3.

FIG. 2 now shows a second exemplary embodiment of the device according to the invention. In order to avoid repetitions and to simplify the description, the same references are used for components which have the same effect, or are equivalent, as in the description of the first exemplary embodiment according to FIGS. 1 to 3, but prefixed with the numeral “1”. In the following, only the differences compared with the first exemplary embodiment according to FIGS. 1 to 3 are explained.

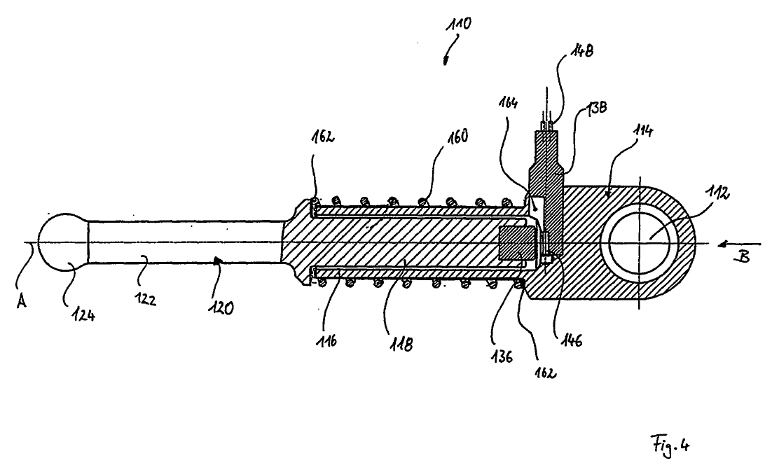

The device 110 according to the second exemplary embodiment shown in FIG. 4 is of an overall more compact design than the device according to the first exemplary embodiment. The hollow cylindrical portion 116 is reduced in its diameter, and accommodates the cylindrical end 18, which is likewise of reduced diameter. Mounted on the hollow cylindrical portion 16 is a helical compression spring 160, which is welded at its ends, by means of spot weldings 162 in each case, to the components force take-up element 114 and force-transmitting element 120. The two components force take-up element 114 and force-transmitting element 120 are thereby held together as a compact assembly. The compression spring 160 nevertheless retains its spring action, and enables the cylindrical end 118 of the force-transmitting element 120 to be inserted telescopically into the hollow cylindrical portion 116 of the force take-up element 114.

In the case of a second exemplary embodiment according to FIG. 4, a permanent magnet 136 is additionally realized in the region of the end face of the cylindrical end 118. The sensor element 146, which complements the permanent magnet, is mounted centrally in the force take-up element 114, at the end of the sensor carrier 138. The sensor carrier 138 is inserted in a slot 164, where it can be pre-positioned.

In other respects, the device 110 according to the second exemplary embodiment functions in the same way as the first exemplary embodiment according to FIGS. 1 to 3. This means that a relative movement between the force take-up element 114 and the force-transmitting element 120 is detected by means of the sensor device 146 on the basis of a displacement of the permanent magnet 136, and forwarded to a controller, not shown, for the purpose of controlling the brake system.

The embodiments described above show a force-admitting element for a vehicle brake system, which is of a comparatively compact design and by means of which a pedal actuation force can be reliably detected.

The advantages of the invention are, in particular, its compactness, its possibility for the provision of a pre-assembled assembly, and its simple and therefore inexpensive design. It is to be pointed out that the exemplary embodiments described above are not be restrictive. Thus, for example, it is possible to replace the described spring elements, such as the conical compression spring 52 and the helical compression spring 160 by spring elements having an equivalent action, e.g. by disc-spring packages, a spring bellows or a spring bushing, which can be elastically compressed in the axial direction.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. Device for the detection of an actuation force of a brake pedal, comprising
a force take-up element coupled to the brake pedal,
a force-transmitting element which is coupled to a brake system and is movable relative to the force take-up element, and
a sensor device, realized as a proximity sensor, for the detection of at least one parameter characterizing the actuation force,
the force take-up element and the force-transmitting element being telescopically displaceable relative to one another and the sensor device being encased by the force take-up element and the force-transmitting element,
wherein the sensor device is disposed between the force take-up element and the force-transmitting element in such a way that, upon a brake-pedal actuation, two components of the sensor device draw axially closer to one another, according to the telescopic displacement of the force take-up element and the force-transmitting element.

2. Device according to claim 1,
wherein there is provided a spring arrangement which forces the force take-up element and the force-transmitting element apart from one another.

3. Device according to claim 2,
wherein the spring arrangement comprises a spiral compression spring which is compressible in the direction of a longitudinal axis running through its centre.

4. Device according to claim 2,
wherein the spring arrangement comprises a helical compression spring.

5. Device according to claim 2,
wherein the spring arrangement is encased by the force take-up element and the force-transmitting element.

6. Device according to claim 1,
wherein the spring arrangement encompasses at least one of the force take-up element and the force-transmitting element.

7. Device according to claim 6,
wherein the spring arrangement is integrally connected to at least one of the force take-up element and the force-transmitting element.

8. Device according to claim 1,
wherein the sensor device comprises a Hall sensor.

9. Device according to claim 1,
wherein a guide pin passes through the force take-up element transversely relative to the direction of the relative movement of the force take-up element and the force-transmitting element, and is displaceable in a guide recess in the force-transmitting element in the direction of the relative movement.

10. Device according to claim 1,
wherein a sensor component of the sensor device is realized on a sensor carrier, the sensor carrier being mounted on a component of the force take-up element and the force-transmitting element, and in that a complementary sensor component of the sensor device is mounted on the respectively other component of the force take-up element and the force-transmitting element, or can be coupled to same.

11. Device according to claim 9,
wherein the sensor carrier is mounted on the force take-up element and is positioned by means of the guide pin.

12. Vehicle brake system, comprising a brake pedal for exerting a pedal actuation force, and a braking-force generator or a brake booster for generating or boosting a braking force according to the pedal actuation force exerted on the brake pedal, characterized by a device according to claim 1, the device being disposed between the brake pedal and the braking-force generator or the brake booster.

13. Device according to claim 1,
wherein the maximum displacement of the force take-up element relative to the force-transmitting element is limited by a stop.
